(19) United States
(12) Patent Application Publication
(10) Pub. No.: US 2026/0245578 A1
(43) Pub. Date: Aug. 20, 2026

(54) SYSTEM AND METHOD FOR IMPROVING OUTLIER DETECTION AT THE PREDICTION STAGE

(71) Applicant: Northwestern Polytechnical University, Xi'an (CN)

(72) Inventors: Jingdong CHEN, Xi'an (CN); Jiawei Yang, Xi'an (CN); Susanto Rahardja, Xi'an (CN)

(73) Assignee: Northwestern Polytechnical University, Xi'an (CN)

(21) Appl. No.: 19/057,585

(22) Filed: Feb. 19, 2025

(51) Int. Cl. G10L 25/60

(52) U.S. Cl. CPC G10L 25/60

(57) ABSTRACT

Training data from a dataset containing multidimensional data may be used to train an outlier detector. A first data sample may then be obtained from the dataset and a set of synthetic data samples may be generated by adding perturbation values to the first data sample, wherein each synthetic data sample is within a multidimensional space surrounding the first data sample. The first data sample may be submitted to the outlier detector to obtain a first score value and the set of synthetic data samples may be submitted to the outlier detector to obtain second score values. An outlier score may be determined based on the first score value and the second score values and the first data sample may be determined to be an outlier based on the outlier score. For example, the outlier score may be a maximum score from the first score and the second scores.

### TECHNICAL FIELD

The present disclosure relates to technical solutions that solve practical challenges in improving the performance of previously-trained and deployed machine learning models without the need for more training, and in particular to methods and systems for using synthetic data during the prediction stage to improve the detection of outliers in a dataset by the previously-trained machine learning model without further training of the model.

### BACKGROUND

Outliers (also known as anomalies) are data samples, from a dataset, that exhibit substantial deviations from the normal data in the dataset. The identification in and removal of outliers from the dataset may be important because of their capacity to negatively influence data analysis regarding a dataset or their capacity to convey essential information regarding a dataset.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 depicts a block diagram of a machine learning model (MLM) for outlier detection being trained and of the trained MLM being used to detect outliers according to some implementations of the present disclosure.

FIG. 2 depicts a flow diagram illustrating an example method for the detection of outliers in a dataset according to some implementations of the present disclosure.

FIG. 3 shows data samples from the dataset including a first data sample from an unreliable area of an outlier detector and several samples generated in a reliable area of the outlier detector around the first data sample by adding perturbation values to the first data sample according to some implementations of the present disclosure.

FIG. 4 illustrates a system for the detection of outliers in a dataset and beamforming for a differential microphone array based on the dataset according to some implementations of the present disclosure.

FIG. 5 is a block diagram illustrating a machine in the example form of a computer system, within which a set or sequence of instructions may be executed to cause the machine to perform any one of the methodologies discussed herein.

### DETAILED DESCRIPTION

Accordingly, outlier detection may play a pivotal role in a wide spectrum of applications such as detecting outliers in acoustic signals received by a microphone array and removing these outlier to improve the performance of a beamformer associated with the microphone array; detecting outliers in speech/audio/video signals and removing these outliers to improve the performance of a trained system (such as a speech recognition system or an image recognition system); detecting anomaly network packets so as to detecting network intrusions and blocking these anomaly network packets from the originating sources; detecting anomaly behaviors in video images for terrorism detection, fake news detection, disease detection and fraud detection; noise removal; rare event detection; and modern system monitoring, to name but a few. Outliers in different applications may be produced through a variety of different mechanisms and therefore no single method for detecting outliers has been universally effective across the different applications. Outlier detection performance may be improved through the more training of machine learning models for the detection of outliers. For example, by collecting or generating representative and comprehensive data samples for training robust and discriminative outlier detection models. However, in practice, the trained machine learning model may have already been deployed in a specific application and cannot be easily updated with further training in real time. When new data including new types of outliers that were not previously presented in the training data during the training of the machine learning model is provided to the trained machine learning model during the prediction stage, the trained machine learning model may not perform well because this training-based approach cannot be easily deployed to outlier detection systems based on machine learning models that have already been trained. Therefore, there is a need for a system and method that can be adapted to improve the outlier detection perform for systems where the trained machine learning model has already deployed.

Furthermore, because datasets containing labeled outliers for supervised learning are difficult and expensive to collect, outlier detector models are generally developed in an unsupervised way. Outlier detection may include simply determining whether a data sample in a dataset is an outlier or not, resulting in a binary classification. However, outlier detection may also include quantifying the degree to which a data sample is an outlier in a dataset. This quantification may be represented by an outlier score, where the outlier score is a quantity that measures the likelihood (or probability) that a data point within a dataset is an outlier.

Throughout this disclosure methods and systems for enhancing the performance of established outlier detectors (e.g., already trained models) during the prediction stage without further adjusting parameters of the trained models or accessing the training data are described. An outlier detector may misclassify samples in certain regions (e.g., of the data space of a dataset), referred to herein as unreliable areas, which may be surrounded by neighboring reliable areas where the outlier detector correctly classifies data samples as normal data or as outlier data. This may happen, for example, because the data in the unreliable areas were not presented in the training dataset. The proposed method can assume that similar data samples (e.g., neighboring samples) should have similar outlier scores. Therefore, the method may assume that the data samples located inside the unreliable areas should have similar outlier scores to their neighboring samples inside the reliable areas and a prediction regarding a given data sample inside an unreliable area can be enhanced by the predictions for similar samples (e.g., neighboring the given sample) inside of reliable areas. Therefore, the prediction of whether a given data sample is an outlier or not may be improved by using outlier prediction results for generated (e.g., synthetic) data samples located in the vicinity of the given data sample. However, the generated data samples may not always be located in reliable areas neighboring the given sample, and may instead be located in neighboring unreliable areas. Accordingly, the improvement to outlier prediction performance for the given sample may be proportional to the number of synthetic data samples that are generated in the neighboring reliable areas. This characteristic (e.g., performance based on number of samples) may be advantageous for big data applications.

Methods and systems described in the present disclosure may be based on the observation that an established outlier detector generally produces similar scores (e.g., outlier scores as described more fully below) for data samples within a certain neighborhood (e.g., close to each other in the data space of a dataset). Therefore, in order to predict an outlier score for a data sample a method may include first generating on-the-fly (e.g., in real time) a group of synthetic data samples by adding random perturbation values within a predetermined range to the data sample and then generating (e.g., predicting) an outlier score for the data sample and for each of the synthetic data samples. These outlier scores may be subsequently fused (e.g., combined according to a rule) and a decision may be made regarding whether the data sample is an outlier based on the fused score. Experiments are carried out to validate the presented method on 22 real-world datasets with 11 detectors including 6 deep-learning-based ones. The results show that the proposed new method can significantly improve the performance of all the tested detectors without further training of the detectors to be tested.

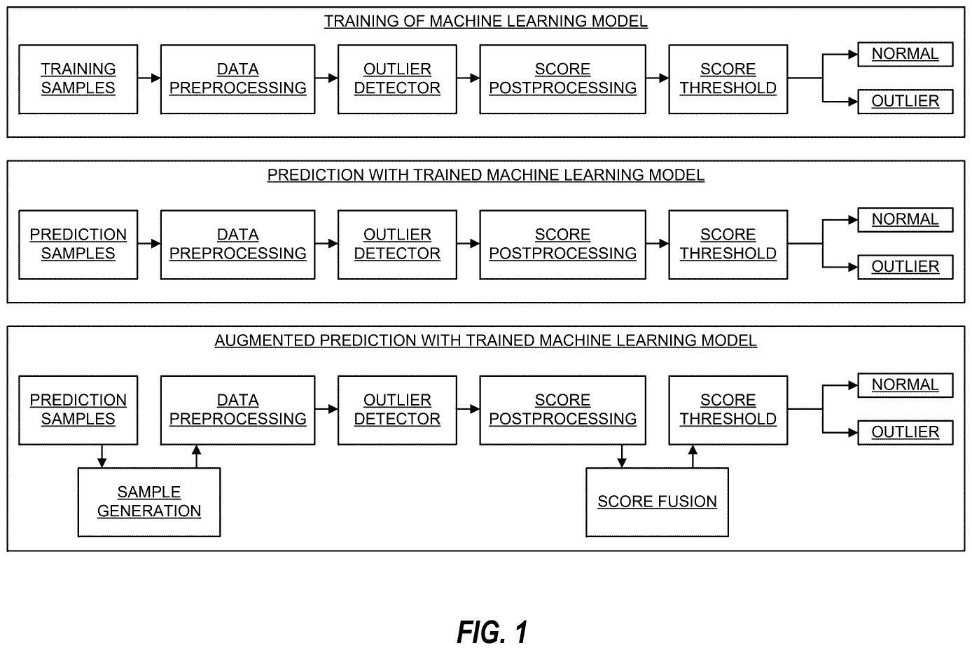

FIG. 1 depicts a block diagram of a machine learning model (MLM) for outlier detection being trained and of the trained MLM being used to detect outliers according to some implementations of the present disclosure.

As noted above the performance of an already trained outlier detector may be enhanced during the predication stage through a two-step process. FIG. 1 illustrates the differences between outlier detection processes with and without the augmentation of the prediction stage as described herein. Both the conventional outlier detection method and the augmented outlier detection method include two main stages: training and prediction (or testing). The conventional and the augmented outlier detection methods share some common components during the training stage/prediction stage (e.g., training samples/prediction samples, data preprocessing, outlier detector, score postprocessing, score threshold, and normal or outlier designation). However, the augmented outlier detection method includes components used for the augmentation of the prediction stage (e.g., sample generation and score fusion) based on the generation of synthetic data samples as described herein. The augmentation improves the outlier detection performance in the prediction stage without further training of the machine learning model.

Training samples: the performance of machine learning models for outlier detection may be affected by the quality of training samples used to train them. Better training samples may be obtained by, for example, increasing the volume of data, generating additional data, rescaling data, transforming data, selecting relevant features, removing outliers, and/or sampling. In scenarios where obtaining additional data is impractical, methods such as self-learning, contrastive learning, and generative learning may be employed to generate synthetic data. Rescaling data, including normalization or standardization may have an impact on outlier detection models. Data transformation, achieved through methods such as coordinate system conversions, principal component analysis, neural networks, random projection, and multiple attribute aggregation, may also influence outlier detection results. The selection of relevant features may be particularly crucial for outlier detectors relying on k-nearest-neighbor-based methods, because they are susceptible to the curse of dimensionality issue (e.g., issues that arise when analyzing/organizing data in a higher-dimensional space that do not occur in a lower-dimensional space). Furthermore, eliminating obvious outliers and/or sampling representative data samples may enhance the performance of outlier detection models.

Outlier detector: Different outlier detectors may be built with distinct principles and assumptions. Consequently, it may be important to select a proper outlier detector based on the specific context and requirements for a given application. For example, distance-based outlier detectors may target the identification of distance-based outliers, density-based detectors may focus on detecting outliers within density-based patterns, while other outlier detectors may aim to identify outliers in the tail end of a distribution or outliers that are dimensionally separable. Therefore, the selection of an appropriate outlier detector may significantly enhance outlier detection performance.

Statistics-based outlier detectors may identify outliers by scrutinizing data samples that deviate significantly from established patterns (e.g., represented by the majority of data samples). Clustering-based outlier detectors may identify outliers by detecting data samples that are sufficiently distant (e.g., compared to a threshold value) from a nearest cluster centroid. Neighborhood-based detectors, also known as proximity-based detectors, may flag outliers as data samples exhibiting substantial distances from their nearest neighboring samples or a notable deviation in density compared to their neighboring samples. Learning-based outlier detectors may extract latent hidden features from data in a dataset by optimizing objective functions. Samples with the most significant impact on these objective functions may be identified as outliers. Ensemble based outlier detectors may fuse/combine the results from multiple outlier detectors to enhance the robustness of outlier detection.

Score thresholding: proper thresholding is another important factor that may greatly affect the accuracy of outlier detection. Thresholding techniques may include static and dynamic thresholding techniques. The main difference between these techniques lies in whether a single outlier score threshold value is applied to all outlier scores or multiple outlier thresholds are applied to different subsets of outlier scores, based on a shift in score distribution among these subsets of outlier scores. The threshold values may be computed based on the distribution of scores or based on statistical methods. Some thresholding methods require user-defined parameters, while others may automatically determine the threshold values without any parameters. Furthermore, the most obviously deviating outlier scores should be excluded from the calculation of threshold values in order to obtain more accurate threshold values.

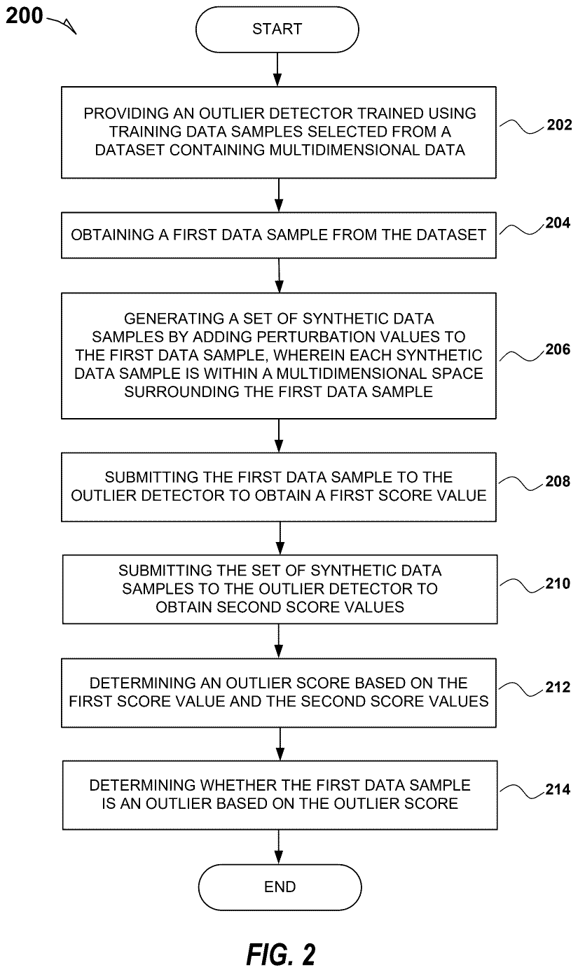

The augmented outlier detection method further includes the sample generation and score fusion components. The sample generation component includes adding perturbation values to a data sample in order to generate synthetic data samples as described more fully below with respect to method 200 of FIG. 2. The score fusion component includes fusing/combining the outlier scores for the data sample and the synthetic data samples before score thresholding as described more fully below with respect to method 200 of FIG. 2. It is important to note that the fusion/combination of scores does not merely refer to combining all the outlier scores because this may not be the optimal approach (e.g., selecting a maximum value score may be a better approach).

FIG. 2 depicts a flow diagram illustrating an example method 200 for the detection of outliers in a dataset according to some implementations of the present disclosure.

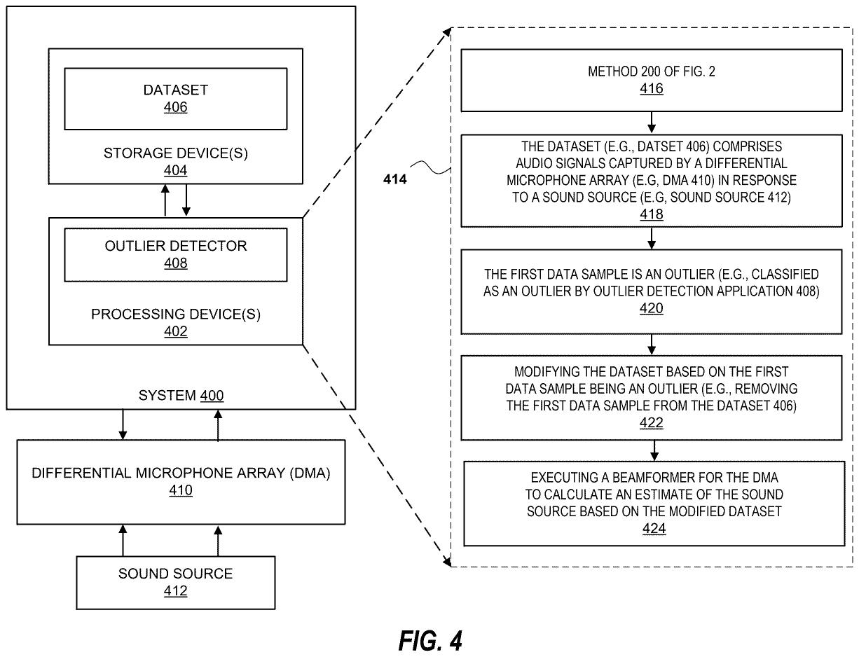

Method 200 for determining whether or not a data sample is an outlier, in a dataset containing multidimensional data (e.g., dataset 406 of FIG. 4 described below), may start and then, at operation 202, may include providing an outlier detector (e.g., outlier detector 408 of FIG. 4 described below) already trained using training data samples selected from the dataset. The outlier detector can be an off-the-shelve machine learning model that had already been trained and deployed and cannot be further trained by the user. The multidimensional data of the dataset may include, for example, data samples that are speech signals, audio signals, image signals, or video signals.

At operation 204, the method 200 may include obtaining a first data sample from the dataset. The disclosed system and method may determine if the first data sample is an outlier.

As noted above, unreliable areas where the outlier detector may not accurately classify data samples as outliers or not (e.g., normal) may be encompassed by reliable areas where the outlier detector accurately classifies data samples as outliers or not. The first data sample Zᵢ (e.g., from a prediction dataset Z including samples from the dataset containing multidimensional data) may be located in an unreliable area of the outlier detector and the scores of similar data samples situated in neighboring reliable areas may be utilized to refine the prediction of an outlier score for the first data sample Zᵢ. The degree to which the outlier prediction performance may be enhanced may be directly proportional to the number of generated synthetic data samples positioned in the neighboring reliable areas. An outlier detector f_{X}(⋅) trained with a dataset X (e.g., including samples from the dataset containing multidimensional data) may predict an outlier score for the first data sample Zᵢ as described below.

At operation 206, the method 200 may include generating a set of synthetic data samples by adding perturbation values to the first data sample, wherein each synthetic data sample is within a multidimensional space surrounding the first data sample.

As noted above, an outlier detector generally yields similar outlier scores for data samples located within the same neighborhood (e.g., close to each other in the data space of a multidimensional dataset). Accordingly, a set of synthetic data samples in the vicinity of first data sample Zᵢ, denoted as Gⁱ, may be generated according to:

$${G}_{j}^{i} = {Z}_{i} + {ε}_{j} , {G}_{j}^{i} ∈ {G}^{i} \qquad ( 1 )$$

where εⱼ is the amount of perturbation to control the samples in set Gⁱ to be within an m-dimensional ball of radius R around the first data sample Zᵢ, i.e.,

$${‖ {ε}_{j} ‖}_{2}^{2} \leq R , {ε}_{j} ∈ {ℝ}^{m} \qquad ( 2 )$$

where m represents the dimension of the multidimensional data of the dataset, R is the radius of the m-dimensional ball, and

$${‖ \cdot ‖}_{2}^{2}$$

denotes the l₂-norm. The number of generated samples may be denoted as S=|Gⁱ|, where |⋅| signifies the number of rows of a matrix, where each row corresponds to a respective data sample.

At operation 208, the method 200 may include submitting the first data sample Zᵢ to the outlier detector f_{X}(⋅) to obtain a first score value denoted as f_{X}(Zᵢ). Here, the outlier detector had been trained using training dataset which may not be designed for the first data sample.

At operation 210, the method 200 may include submitting the set of synthetic data samples Gⁱ to the outlier detector f_{X}(⋅) to obtain second score values denoted as

$${f}_{X} ( {G}_{j}^{i} ) .$$

At operation 212, the method 200 may include determining an outlier score oᵢ based on the first score value f_{X}(Zᵢ) and the second score values

$${f}_{X} ( {G}_{j}^{i} ) .$$

The outlier score for Zᵢ, i.e., f_{X}(Zᵢ), may be combined with the scores of the generated samples Gⁱ, i.e.

$${f}_{X} ( {G}_{j}^{i} ) ,$$

to obtain the final score oᵢ for the outlier classification decision (e.g., normal or outlier) regarding the first data sample Zᵢ. For example, the maximum score value from among the first score value f_{X}(Zᵢ) and the second score values

$${f}_{x} ( {G}_{j}^{i} )$$

may be selected as the final outlier score for Zᵢ. Mathematically, this may be written as:

$${o}_{i} = max \{ {f}_{X} ( {Φ}_{j}^{i} ) \vert {Φ}_{j}^{i} ∈ {Φ}^{i} \} with {Φ}^{i} = \{ {Z}_{i} \} ⋃ {G}^{i} \qquad ( 3 )$$

At operation 214, the method 200 may include determining whether the first data sample Zᵢ is an outlier based on the outlier score oᵢ.

For example, determining whether the first data sample Zᵢ is an outlier based on the outlier score oᵢ comprises determining whether the outlier score oᵢ is greater than a threshold value.

A comprehensive analysis of the augmented prediction may be conducted by leveraging the concept of analyzing an unsupervised outlier detector ensemble through a bias-variance tradeoff. In this analysis, it may be assumed that the optimal outlier score for a given sample Zᵢ∈Z is determined by an unknown function denoted as g(⋅), which may be estimated using an outlier detector denoted by f(⋅). It may be assumed that both g(⋅) and f(⋅) generate scores that have a mean of zero and a variance of one across all samples Zᵢ∈Z. The average error of the outlier detector f(⋅), computed over all the samples to predict, may then be expressed as:

$$J = \frac{1}{m} {\sum }_{i = 1}^{m} {\{ g ( {Z}_{i} ) - f ( {Z}_{i} ) \}}^{2} \qquad ( 4 )$$

After introducing random perturbation values εⱼ to Zᵢ, the synthetic data samples (e.g., Gⁱ) may be generated as \hat{Z}ᵢ=Zᵢ+εⱼ. The outlier score of Zᵢ may be calculated by combining the outlier scores of \hat{Z}ᵢ. The expected average error may then be expressed as:

$$ξ = 𝔼 [ J ] = \frac{1}{m} {\sum }_{i = 1}^{m} 𝔼 [ {\{ g ( {Z}_{i} ) - f ( {\hat{Z}}_{i} ) \}}^{2} ] = {ξ}_{B} + {ξ}_{V} \qquad ( 5 )$$

where [symbol] [⋅] denotes the mathematical expectation, and

$${ξ}_{B} = \frac{1}{m} {\sum }_{i = 1}^{m} {𝔼 [ {\{ g ( {Z}_{i} ) - 𝔼 [ f ( {\hat{Z}}_{i} ) ] \}}^{2} ]}_{} \qquad ( 6 )$$

$${ξ}_{V} = \frac{1}{m} {\sum }_{i = 1}^{m} {𝔼 [ {\{ 𝔼 [ f ( {\hat{Z}}_{i} ) ] - f ( {\hat{Z}}_{i} ) \}}^{2} ]}_{} \qquad ( 7 )$$

correspond, respectively, to the squared bias and variance components.

Different algorithms may be derived to minimize the expected average error ξ by minimizing either ξ_{B} or ξ_{V} or both at the same time. For example, the variance component ξ_{V} may be minimized by setting

$${\hat{Z}}_{i} = {Z}_{i} + {ε}_{j} = {G}_{j}^{i} ,$$

where

$${G}_{j}^{i} ∈ {Φ}^{i} ,$$

which is defined in equation (3). The perturbation term, i.e.,

$${‖ {ε}_{j} ‖}_{2}^{2} = {‖ {G}_{j}^{i} - {Z}_{i} ‖}_{2}^{2} ,$$

may be controlled to be small (e.g., through adjusting the radius R). Consequently, the term { [symbol] [f(\hat{Z}ᵢ)]−f(\hat{Z}ᵢ)}₂ is also small, and so is the variance component ξ_{V}.

Method 200 may be performed by processing devices that may comprise hardware (e.g., circuitry, dedicated logic), computer readable instructions (e.g., run on a general-purpose computer system or a dedicated machine), or a combination of both. Method 200 and each of its individual functions, routines, subroutines, or operations may be performed by one or more processors of the computer device executing the method. In certain implementations, method 200 may be performed by a single processing thread. Alternatively, method 200 may be performed by two or more processing threads, each thread executing one or more individual functions, routines, subroutines, or operations of the method. In one implementation, method 200 may be performed by the processing devices 402 executing outlier detector 408 as described below with respect to FIG. 4.

Additionally, for simplicity of explanation, the training steps are depicted and described herein with a specific order. It should be appreciated, however, that the training operations may occur in various orders, concurrently, and/or with other operations not presented or described herein. Furthermore, it should be noted that not all operations that may be included in the training process are depicted and described herein, and not all illustrated operations are required to be performed.

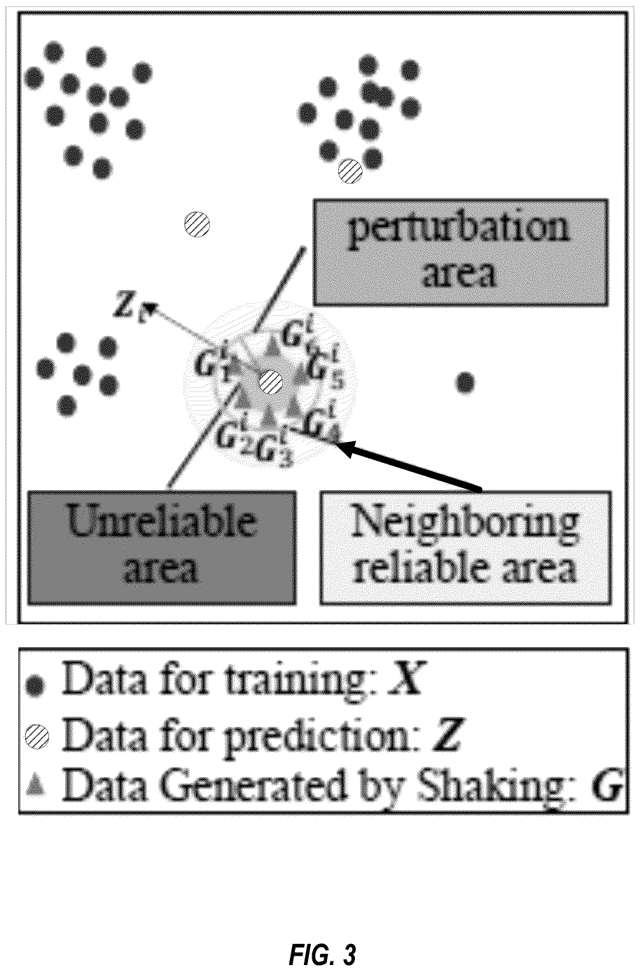

FIG. 3 shows data samples from the dataset including a first data sample Zᵢ from an unreliable area of an outlier detector f_{X}(⋅) and several samples Gⁱ generated in a reliable area of the outlier detector f_{X}(⋅) around the first data sample Zᵢ by adding perturbation values εᵢ to the first data sample Zᵢ according to some implementations of the present disclosure.

The sample Zᵢ (shown as a striped circle along with other data samples from the dataset Z for prediction of outlier scores), which is located in the unreliable area of the detector f_{X}(⋅) trained with dataset X (data samples from X shown as solid circles), would be assigned with an inaccurate outlier score o_{Z}_{ᵢ}=f_{X}(Zᵢ). As described above the augmented prediction stage addresses this issue in two steps. Firstly, a set of synthetic data samples

$${G}_{j}^{i}$$

(with j=1, 2, . . . 6; shown as solid triangles) may be generated in the vicinity of Zᵢ (e.g., within an m-dimensional ball of radius R around the first data sample Zᵢ) by adding perturbation values & to the first data sample Zᵢ, with the intention of including some data samples

$${G}_{j}^{i}$$

within the reliable area surrounding Zᵢ. Secondly, the f_{X}(⋅) outlier prediction scores for Zᵢ and for the generated data samples

$${G}_{j}^{i}$$

may be combined to determine the outlier prediction score for Zᵢ

$$( e . g . , {o}_{i} = max \{ {f}_{X} ( {Φ}_{j}^{i} ) \vert {Φ}_{j}^{i} ∈ {Φ}^{i} \} with {Φ}^{i} = \{ {Z}_{i} \} ⋃ \{ {G}_{j}^{i} \vert j = 1 , 2 , … 6 \}$$

according to (3) above).

Accordingly, the algorithm for the local augmentation (LA) of the prediction stage may be denoted as:

$$LA ( {f}_{X} ( \cdot ) , Z , S , R ) \to o$$

Inputs: A detector f_{X}(⋅) trained with the dataset X⊂ [symbol] ^{N×m};
A dataset to predict Z⊂ [symbol] ^{n×m};
The number of samples to be generated: S⊂N⁺;
The radius of the m-dimensional ball: R⊂ [symbol] ⁺;
Outputs: Outlier scores o⊂ [symbol] ⁿ;
1. For Every Sample Zᵢ⊂Z:
2.

$${Φ}^{i} ← \{ {Z}_{i} \} ⋃ \{ {G}_{j}^{i} = {Z}_{i} + {ε}_{j} \vert j ∈ {ℕ}^{+} ; j ∈ [ 1 , S ] ; {ε}_{j} ∈ {ℝ}^{m} ; {‖ {ε}_{j} ‖}_{2}^{2} \leq R \}$$

(e.g., synthetic data sample generation according to (1) above);
3.

$${o}_{i} ← max \{ {f}_{X} ( {Φ}_{j}^{i} ) \vert {Φ}_{j}^{i} ∈ {Φ}^{i} \}$$

(e.g., score combination according to (3) above);
4. End For.

FIG. 4 illustrates a system 400 for the detection of outliers in a dataset 406 and beamforming for a differential microphone array (DMA) 410 based on the dataset 406 according to some implementations of the present disclosure. The performance of beamforming for DMA may be affected by outliers in the input data. Therefore, there is a need to detect and removal outliers from the input data to a DMA.

System 400 may be a standalone computer or a networked computing resource implemented in a computing cloud. System 400 may include one or more processing device(s) 402 and storage device(s) 404 storing a multidimensional dataset 406 from which data samples for training/prediction with outlier detector 408 may be obtained. The storage device(s) 404 are communicatively coupled to processing device(s) 402.

In some embodiments, the trained outlier detector 408 may comprise a deep learning model that uses one-class classifications, autoencoders, self-supervised learning, contrastive learning, scale learning or ensembles to detect outliers in the dataset 406. Furthermore, in other embodiments the trained outlier detector 408 may comprise a non-deep learning model that uses neighborhoods, random forests, support vector machines or ensembles to detect outliers in the dataset 406.

As noted above, the multidimensional dataset 406 may comprise one or more data samples consisting of speech signals, audio signals, image signals, or video signals. The outlier detector 408 (e.g., f_{X}(⋅) as described with respect to FIGS. 2 and 3 above) may be trained to calculate an outlier score (e.g., oᵢ as described with respect to FIGS. 2 and 3 above) for a data sample (e.g., Zᵢ as described with respect to FIGS. 2 and 3 above) from the dataset 406. System 400 may be suitable for many practical applications. For example, based on an outlier score being greater than the relevant threshold value, the one or more processing device(s) 402 may: determine that an application for a credit card or the use of a credit card is fraudulent; determine that access to a computer network is unauthorized; determine that the performance of a computer network is being affected by a network data bottleneck; determine that a motor, generator or pipeline is faulty; or determine that a medical condition has changed (e.g., based on data from a medical monitoring device) and take further responsive actions in real-time.

System 400 may be connected to at least one a differential microphone array (DMA) 410 (e.g., via a network connection). The DMA 410 may capture audio signals from a sound source 412 and transmit the captured signals to system 400 for outlier detection (e.g., by outlier detector 408) with respect to the captured signal data (e.g., in real-time) so that beamforming can be performed based on a dataset of captured signals for which outlier detection has already been performed. Beamforming is a technique used to improve the signal-to-noise ratio of received signals (e.g., audio signals from sound source 412) by eliminating undesirable interference sources (e.g., based on outlier data samples) and focusing transmitted signals to specific locations (e.g., towards microphone sensors of DMA 410)

The operations (e.g., performed by processing device(s) 402/outlier detector 408) for calculating an estimate of sound source 412 by executing a beamformer for DMA 410 are describe through the flow diagram 414.

Referring to flow diagram 414, at operation 416, processing device(s) 402 may first perform operations 202-214 of method 200 of FIG. 2 (as described above) with respect to dataset 406 described below at operation 418.

At operation 418, the dataset 406 comprises audio signals captured by a differential microphone array (DMA 410) in response to a sound source 412.

At operation 420, the first data sample (e.g., Z₁ as described with respect to FIGS. 2 and 3 above) is determined to be an outlier (e.g., classified as an outlier of dataset 406 by outlier detector 408 using method 200 of FIG. 2).

At operation 422, the one or more processing device(s) 402 may modify the dataset 406 based on the first data sample being determined to be an outlier (e.g., modify dataset 406 by removing the first data sample from the dataset 406 if the first data sample is determined to be an outlier).

At operation 424, the one or more processing devices may execute a beamformer for the DMA 410 to calculate an estimate of the sound source 412 based on the modified dataset 406.

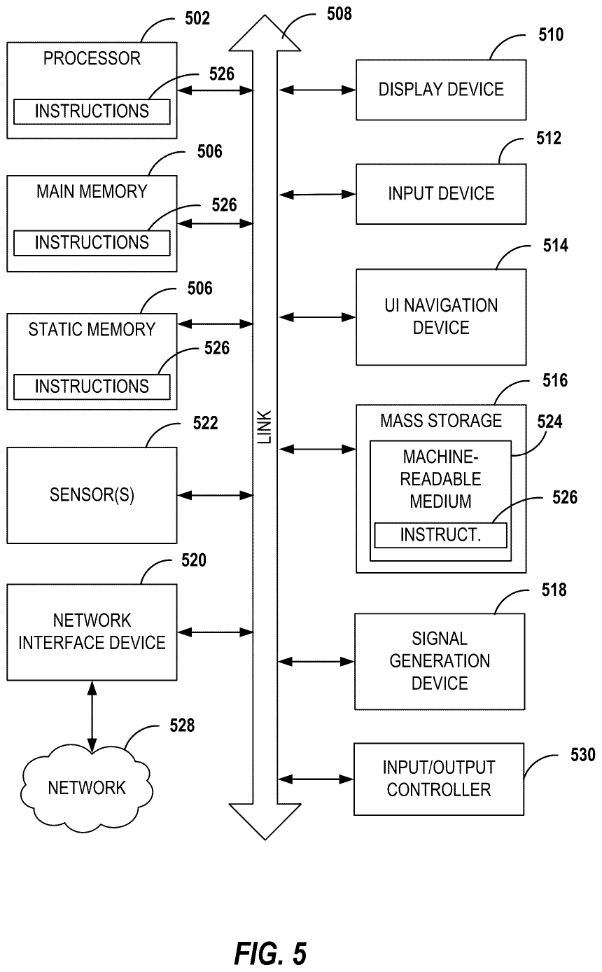

FIG. 5 is a block diagram illustrating a machine in the example form of a computer system 500, within which a set or sequence of instructions may be executed to cause the machine to perform any one of the methodologies discussed herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein (e.g., method 200 of FIG. 2).

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors 522, such as a global positioning system (GPS) sensor, accelerometer, gyrometer, magnetometer, or other such sensor.

The storage device 516 includes a machine-readable medium 524 on which is stored one or more sets of data structures and instructions 526 (e.g., software) embodying or utilized by any one or more of the methodologies or functions described herein. The instructions 526 may also reside, completely or at least partially, within the main memory 504, static memory 506, and/or within the processor 502 during execution thereof by the computer system 500, with main memory 504, static memory 506, and the processor 502 comprising machine-readable media.

While the machine-readable medium 524 is illustrated in an example embodiment to be a single medium, the term “machine-readable medium” may include a single medium or multiple media (e.g., a centralized or distributed database, and/or associated caches and servers) that store the one or more instructions 526. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include volatile or non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 526 may further be transmitted or received over a communications network 528 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 16G LTE/LTE-A or WiMAX networks). The term “transmission medium” shall be taken to include any intangible medium that is capable of storing, encoding, or carrying instructions for execution by the machine, and includes digital or analog signals or other intangible medium to facilitate communication of such software.

Example computer system 500 may also include an input/output controller 530 to receive input and output requests from at least one central processor 502, and then send device-specific control signals to the device they control. The input/output controller 530 may free at least one central processor 502 from having to deal with the details of controlling each separate kind of device.

The term “computer-readable storage medium” used herein may include any tangible medium that is capable of storing or encoding a set of instructions for execution by a computer that cause the computer to perform any one or more of the methods described herein. The term “computer-readable storage medium” used herein may include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A method for determining whether a data sample is an outlier or not, the method comprising:
providing an outlier detector trained using training data samples selected from a dataset containing multidimensional data;
obtaining a first data sample from the dataset;
generating a set of synthetic data samples by adding perturbation values to the first data sample, wherein each synthetic data sample is within a multidimensional space surrounding the first data sample;
submitting the first data sample to the outlier detector to obtain a first score value;
submitting the set of synthetic data samples to the outlier detector to obtain second score values;
determining an outlier score based on the first score value and the second score values; and
determining whether the first data sample is an outlier based on the outlier score.

2. The method of claim 1, wherein the dataset comprises audio signals captured by a differential microphone array (DMA) in response to a sound source and the first data sample is determined to be an outlier, the method further comprising modifying the dataset based on the first data sample being an outlier and executing a beamformer for the DMA to calculate an estimate of the sound source based on the modified dataset.

3. The method of claim 1, wherein determining the outlier score based on the first score value and the second score values comprises selecting a maximum score value from the first score value and the second score values.

4. The method of claim 1, wherein the data samples are one of speech signals, audio signals, image signals, or video signals.

5. The method of claim 1, wherein the dataset contains m-dimensional data and the multidimensional space surrounding the first data sample comprises an m-dimensional ball centered on the first data sample.

6. The method of claim 5, wherein the m-dimensional ball centered on the first data sample has a radius R determined by the perturbation values added to the first data sample.

7. The method of claim 1, wherein determining whether the first data sample is an outlier based on the outlier score comprises determining whether the outlier score is greater than a threshold value.

8. The method of claim 7, wherein based on the outlier score being greater than the threshold value, the method further comprises:
determining that an application for a credit card or the use of a credit card is fraudulent;
determining that access to a computer network is unauthorized;
determining that the performance of a computer network is being affected by a network data bottleneck;
determining that a motor, generator or pipeline is faulty; or
determining that a medical condition has changed.

9. The method of claim 1, wherein the trained outlier detector comprises a deep learning model that uses one-class classifications, autoencoders, self-supervised learning, contrastive learning, scale learning or ensembles to detect outliers in the dataset.

10. The method of claim 9, wherein the trained outlier detector comprises a non-deep learning model that uses neighborhoods, random forests, support vector machines or ensembles to detect outliers in the dataset.

11. A system for determining whether a data sample is an outlier or not, the system comprising one or more processing devices and one or more storage devices for storing instructions that when executed by the one or more processing devices cause the one or more processing devices to:
provide an outlier detector trained using training data samples selected from a dataset containing multidimensional data;
obtain a first data sample from the dataset;
generate a set of synthetic data samples by adding perturbation values to the first data sample, wherein each synthetic data sample is within a multidimensional space surrounding the first data sample;
submit the first data sample to the outlier detector to obtain a first score value;
submit the set of synthetic data samples to the outlier detector to obtain second score values;
determine an outlier score based on the first score value and the second score values; and
determine whether the first data sample is an outlier based on the outlier score.

12. The system of claim 11, wherein the dataset comprises audio signals captured by a differential microphone array (DMA) in response to a sound source and the first data sample is an outlier, the one or more processing devices are further to modify the dataset based on the first data sample being an outlier and execute a beamformer for the DMA to calculate an estimate of the sound source based on the modified dataset.

13. The system of claim 11, wherein to determine the outlier score based on the first score value and the second score values comprises selecting a maximum score value from the first score value and the second score values.

14. The system of claim 11, wherein the data samples are one of speech signals, audio signals, image signals, or video signals.

15. The system of claim 11, wherein the dataset contains m-dimensional data and the multidimensional space surrounding the first data sample comprises an m-dimensional ball centered on the first data sample.

16. The system of claim 15, wherein the m-dimensional ball centered on the first data sample has a radius R determined by the perturbation values added to the first data sample.

17. The system of claim 11, wherein to determine whether the first data sample is an outlier based on the outlier score comprises determining whether the outlier score is greater than a threshold value.

18. The system of claim 17, wherein based on the outlier score being greater than the threshold value, the one or more processing devices are further to:
determine that an application for a credit card or the use of a credit card is fraudulent;
determine that access to a computer network is unauthorized;
determine that the performance of a computer network is being affected by a network data bottleneck;
determine that a motor, generator or pipeline is faulty; or
determine that a medical condition has changed.

19. The system of claim 11, wherein the trained outlier detector comprises a deep learning model that uses one-class classifications, autoencoders, self-supervised learning, contrastive learning, scale learning or ensembles to detect outliers in the dataset.

20. The system of claim 11, wherein the trained outlier detector comprises a non-deep learning model that uses neighborhoods, random forests, support vector machines or ensembles to detect outliers in the dataset.
